(19) United States
(12) Patent Application Publication
(10) Pub. No.: US 2008/0170048 A1
(43) Pub. Date: Jul. 17, 2008

(54) Retractable contact-control pen for electric device

(75) Inventor: Richard Hua, Taipei City (TW)

Correspondence Address: BACON & THOMAS, PLLC, 625 SLATERS LANE, FOURTH FLOOR, ALEXANDRIA, VA, 22314, US

(73) Assignee: Great Performance Industries Co., Ltd., Taipei City (TW)

(21) Appl. No.: 11/653,992

(22) Filed: Jan. 17, 2007

(51) Int. Cl. G06F 3/033

(52) U.S. Cl. 345/179

(57) ABSTRACT

A retractable contact-control pen with an inner rod having near its front end a position limiting area that is provided with two protrusions pressed by a compression spring to be normally pressed against the inner wall of a hollow outer rod, when the inner and the outer rods slide relative to each other, by pressing of the inner rod against the inner wall of the outer rod, the inner rod can keep its stable sliding; moreover, the outer rod has on its tailing end an opening with a reduced diameter; the inner rod has a first flange at the rear of the position limiting area and with a diameter larger than that of the opening; so that when the entire retractable contact-control pen is pulled to elongate for use, the first flange is pressed against the periphery of the opening and stops there, the entire retractable contact-control pen thus has a better strength.

### BACKGROUND OF THE INVENTION

1. Field of the Invention

The present invention relates to a retractable contact-control pen for an electric device, and especially to a retractable contact-control pen for an electric device which is meant to be a PDA, a cell phone, a pocket computer or a plane computer.

2. Description of the Prior Art

Generally, an electric device such as a PDA, a cell phone, a pocket computer or a plane computer mostly is built to have a contact-control panel in order that a user can write letters on the contact-control panel with a contact-control pen, or can select by dotting a related functional item; and more, for meeting the requirement of convenience of carrying and the design of style of an electric device, contact-control pens with similar functions mostly are designed to have a retractable contact-control pen structure as shown in FIG. 1, such a retractable contact-control pen with similar functions is composed by slipping one over the other of an inner rod 20 and an outer rod 10.

When the user writes by holding a retractable contact-control pen, he can elongate the retractable contact-control pen to render the user to get firmness in holding the retractable contact-control pen; on the contrary, when the retractable contact-control pen is not in use, the inner rod 20 can be pressed into and stored in the outer rod 10 to reduce the length of the pen and to increase the convenience of storing and carrying.

Moreover, in order to avoid shaking during the process of stretching or retracting that may affect the quality and feeling of quality of a product, mostly the retractable contact-control pen is provided with a related auxiliary mechanism between the inner rod 20 and the outer rod 10 to increase stability of relative sliding of the inner rod 20 to the outer rod 10.

FIG. 2 shows a retractable contact-control pen structure with an auxiliary mechanism, such a conventional retractable contact-control pen is provided at two mutually opposite positions in the inner rod 20 with two spring sheets 40, the elastic extension forces of the two spring sheets 40 have certain degrees of friction contact with the inner wall of the outer rod 10 to increase stability of relative sliding of the inner rod 20 to the outer rod 10.

However, by virtue that the spring sheets 40 are designed to be uneasy for controlling the friction forces of them with the outer rod 10, plus that the inner rod 20 and the two spring sheets 40 are engaged by protruding points with recessing points, the outer rod 10 and the inner rod 20 may create noise during being stretched; and when the outer rod 10 and the inner rod 20 are stretched to the longest, the spring sheets 40 will impact the end with reduced diameter of the outer rod 10, such impact force will be transmitted to the engaging areas of the spring sheets 40 with the inner rod 20. And after being used for a long time, it is inevitable that the protruding points and recessing points may be worn, broken, and even the inner rod 20 may be drawn out completely just by a slight force, hence there is a space for further improvement.

Further, FIG. 3 shows another kind of retractable contact-control pen structure with an auxiliary mechanism, on such a conventional retractable contact-control pen, certain degrees of friction contact of a rubbery ring 50 of the inner rod 20 with the inner wall of the outer rod 10 is created to increase stability of relative sliding of the inner rod 20 to the outer rod 10.

However, for such a retractable contact-control pen, lubricating oil must be filled in the space between the inner rod 20 and the outer rod 10 to maintain the smoothness of the relative sliding of the inner rod 20 to the outer rod 10, not only the friction force, but even also the drawing force is uneasy to be controlled, especially when in losing the lubricating oil by flowing, stretching/retracting of the inner rod 20 relative to the outer rod 10 are more difficult for handling.

### SUMMARY OF THE INVENTION

In view of the above stated, the primary object of the present invention is to provide a retractable contact-control pen for an electric device, which retractable contact-control pen is structurally stronger and easier for drawing, and has a longer life of use and lower noise during operation as well as can maintain the same drawing force during operation. The whole contact-control pen comprises mainly a hollow outer rod and an inner rod that can be slipped into the outer rod for stretching or retracting by relative sliding.

Wherein the inner rod has near its front end a position limiting area which is provided with a positioning hole extending radially, further the positioning hole is provided therein with a compression spring and a pair of protrusions on the two ends of the compression spring, the pair of protrusions are pressed by the compression spring to keep their function of pressing against the inner wall of the hollow outer rod; when the inner and the outer rods slide relative to each other, by the function of pressing of the inner rod against the inner wall of the hollow outer rod, the inner rod can keep its stable sliding; particularly, the resilient force of the compression spring can be used to control the pulling or drawing force on the inner and the outer rods, when the protrusions are worn, the function of pressing of the compress ion spring can make up this to keep the inner and the outer rods under the same drawing force.

Moreover, the outer rod has on its tailing end an opening which is an opening with a reduced diameter; the inner rod has a first flange at the rear of the position limiting area and with a diameter larger than that of the opening with the reduced diameter; so that when the entire retractable contact-control pen is pulled to elongate for use, the first flange is pressed against the periphery of the opening with the reduced diameter and stops there, not only the noise in operation can be lowered, but also the entire retractable contact-control pen has a better strength, this can effectively prolong the life of the contact-control pen.

The present invention will be apparent in the modes of practicing the present invention according to the technical measures of the present invention after reading the detailed description of the preferred embodiment thereof in reference to the accompanying drawings.

### BRIEF DESCRIPTION OF THE DRAWINGS

FIG. 1 is a perspective view showing the appearance of a conventional retractable contact-control pen;

FIG. 2 is an anatomic perspective view showing the structure of the conventional retractable contact-control pen;

FIG. 3 is an anatomic perspective view showing the structure of another conventional retractable contact-control pen;

FIG. 4 is a perspective view showing the appearance of a first embodiment of the present invention;

FIG. 5 is an anatomic perspective view showing the structure of the first embodiment of the present invention;

FIG. 6 is a sectional view showing the structure of the first embodiment of the present invention;

FIG. 7 is a sectional view showing the structure of a second embodiment of the present invention;

FIG. 8 is an anatomic perspective view showing the structure of the third embodiment of the present invention.

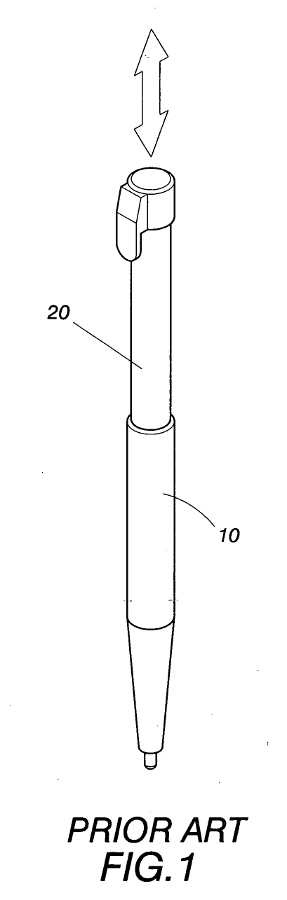

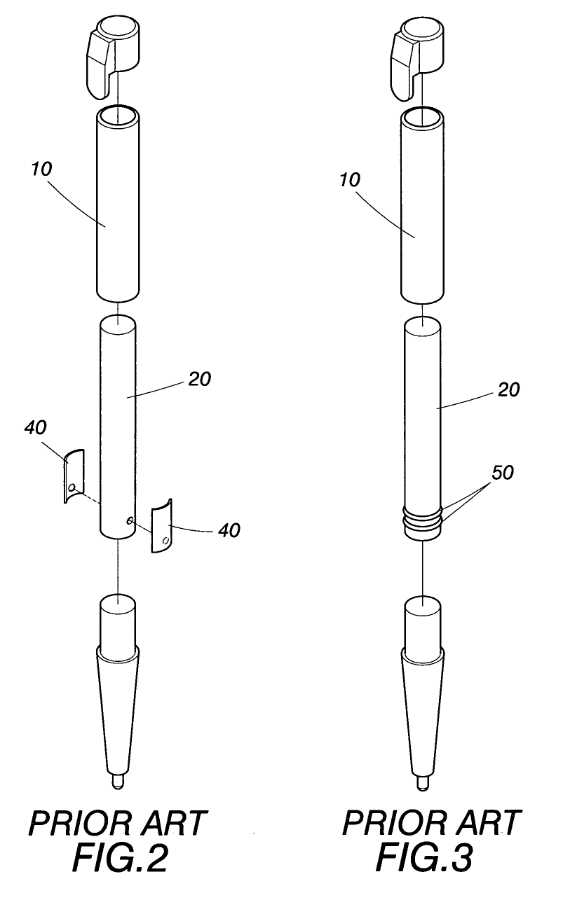

### DETAILED DESCRIPTION OF THE PREFERRED EMBODIMENT

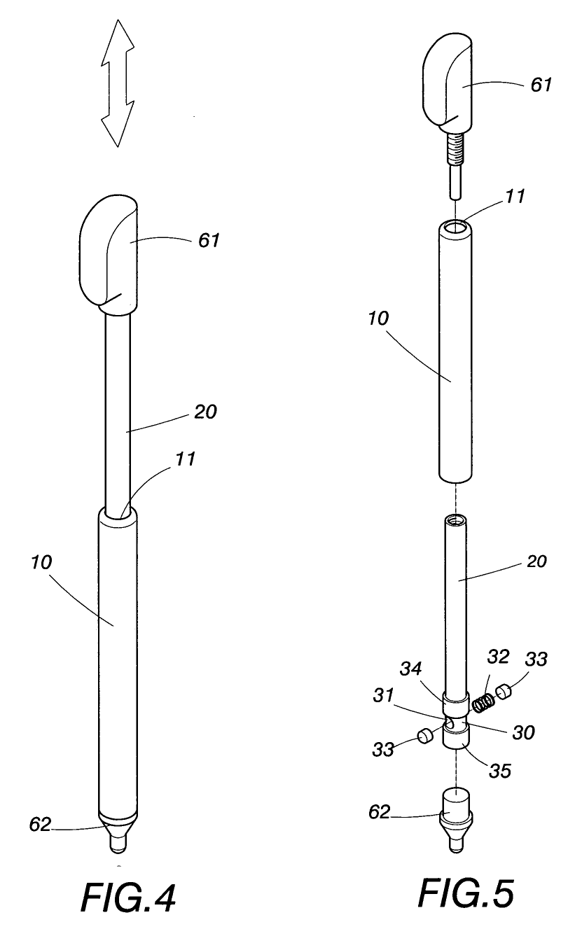

Referring firstly to FIG. 4, the retractable contact-control pen for an electric device of the present invention is a contact-control pen that is structurally stronger and easier for drawing or pulling, and has a longer life of use and lower noise during operation as well as can maintain the same drawing force during operation. As shown in FIG. 4 which is a perspective view showing the appearance of the present invention, the whole contact-control pen comprises mainly a hollow outer rod 10 and an inner rod 20 that can be slipped into the outer rod 10 for stretching or retracting by relative sliding. The cross-sections of the outer rod 10 and the inner rod 20 can be circular, elliptical or polygonal able to fit with each other.

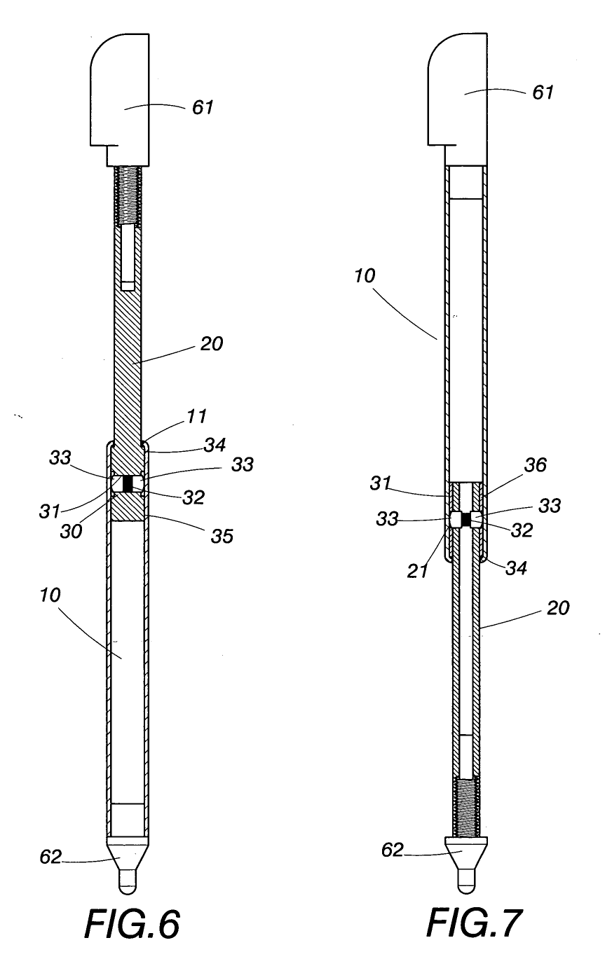

Please refer also to FIGS. 5 and 6 which both show the structure of the present invention, wherein the inner rod 20 has near its front end a position limiting area 30 which is provided with a positioning hole 31 extending radially, further the positioning hole 31 is provided therein with a compression spring 32 and a pair of protrusions 33 on the two ends of the compression spring 32, the pair of protrusions 33 are pressed by the compression spring 32 to keep their function of pressing against the inner wall of the hollow outer rod 10.

And the outer rod 10 has on its tailing end an opening 11 which is an opening with a reduced diameter; the inner rod 20 has a first flange 34 at the rear of the position limiting area 31 and with a diameter larger than that of the opening 11 with the reduced diameter; so that when the entire retractable contact-control pen is pulled to elongate for use, the first flange 34 is pressed against the periphery of the opening 11 with the reduced diameter and stops there, not only the noise in operation can be lowered, but also the entire retractable contact-control pen has a better strength, this can effectively prolong the life of the contact-control pen.

By the fact the two protrusions 33 on the front end of the inner rod 20 are pressed by the compression spring 32 to keep their function of pressing against the inner wall of the hollow outer rod 10, when the inner and the outer rods 20, 10 slide relative to each other, the inner rod 20 can keep its stable sliding by pressing of the two protrusions 33 against the inner wall of the hollow outer rod 10; particularly, the resilient force of the compression spring 33 can be used to control the pulling or drawing force on the inner and the outer rods 20, 10, when the protrusions 33 are worn, the function of pressing of the compression spring 32 can make up this to keep the inner and the outer rods 20, 10 under the same drawing force.

In the embodiment shown in FIGS. 4 to 6, the retractable contact-control pen has a pen cap 61 on the tailing end of the inner rod 20, and a nib 62 on the front end of the outer rod 10 in order that the contact-control pen is convenient for operation and writing, and the structure of the contact-control pen gets its entirety, and the inner rod 20 is integrally provided near its front end with the position limiting area 30 which is a solid rod-like structure.

Surely, the inner rod 20 can be a hollow tube-like structure provided also with the positioning hole 31, the compression spring 32 and the two protrusions 33 as are shown in FIG. 7, while wherein the first flange 34 is provided on a cylindrical collar 36 which fixedly wraps the front end of the hollow inner rod 20 by screw connecting, sticking, punch pressing protruding points for clamping connecting etc. the cylindrical collar 36 is provided thereon with through holes 21 for extending therethrough of the two protrusions 33. Further in this embodiment, the nib 62 is provided on the tailing end of the inner rod 20, and the pen cap 61 is provided on the front end of the outer rod 10, thus the contact-control pen is convenient in operation and writing.

And more, in addition to that the entire retractable contact -control pen takes advantage of normally having the two protrusions 33 pressed against the inner wall of the hollow outer rod 10 to keep stable sliding of the inner and the outer rods 20, 10 relative to each other, the inner rod 20 is provided with a second flange 35 on its front end, and of which the positioning hole 31, the compression spring 32 and the two protrusions 33 are allocated between the first and the second flanges 34, 35 to increase the stability of the inner and the outer rods 20, 10; the distance between the first and the second flanges 34, 35 can be adjusted or increased appropriately without influencing the stretching/retracting stroke of the inner and the outer rods 20 and 10, or can be changed to adjust the stretching/retracting stroke of the inner and the outer rods 20, 10.

Surely, the outer surfaces of the two protrusions 33 can be designed to be coincident both with an arciform protruding surface 332 of the inner wall of the outer rod 10, this can increase the friction contact areas of the two protrusions 33 with the inner rod 20, and similarly can increase the stability of the inner and the outer rods 20, 10.

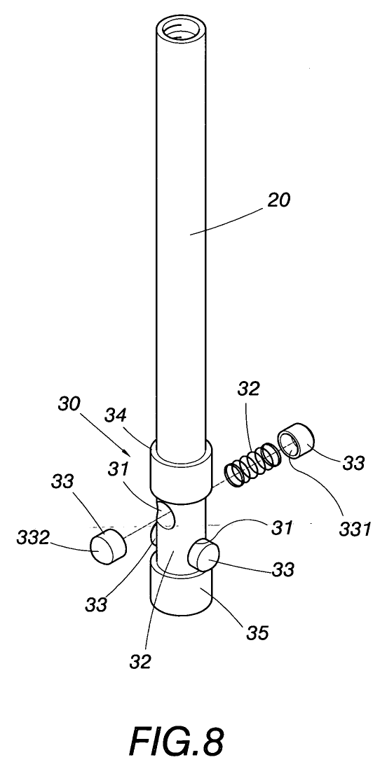

One thing is worth mentioning, as shown in FIG. 8, more than one positioning hole 31 neighbored with each other are provided to have therein each a compression spring 32 and two protrusions 33, the inner surface of each protrusion 33 is provided with a recess 331 for embedding therein of one of the compression spring 32; and more, the positioning holes 31 can be arranged to be perpendicular one to the other, in this mode, the amount of the protrusions 33 can be increased, and the scope and orientations of action of the protrusions 33 can be broadened/increased.

The above design of structure can be put to practice with a specific machine and specific tools for production, the products completed can surely increase the structural strength of the retractable contact-control pen and increase the stability in stretching/retracting, and can lower noise during operation; particularly, the protrusions 33 can be made according to the drawing force on the inner and the outer rods 20, 10 under control of the resilient force of the compression spring 32 or made of abrading durable material selected; even when the protrusions 33 are worn, the function of pressing of the compression spring 32 can make up this to keep the inner and the outer rods 20, 10 under the same drawing force, this can effectively prolong the life of the contact-control pen.

The above stated and expressed by drawings are only for illustrating preferred embodiments of the present invention, it will be apparent to those skilled in this art that various equivalent modifications or changes without departing from the spirit of this invention shall also fall within the scope of the appended claims.

1. A retractable contact-control pen for an electric device comprising:
a hollow outer rod; and
an inner rod that is slipped into said outer rod for stretching or retracting by relative sliding; said inner rod has near its front end a position limiting area which is provided with a positioning hole extending radially, further said positioning hole is provided therein with a compression spring and a pair of protrusions on the two ends of said compression spring, said pair of protrusions are pressed by said compression spring to keep their function of pressing against an inner wall of said hollow outer rod.

2. The retractable contact-control pen for an electric device as in claim 1, wherein: said hollow outer rod has on its tailing end an opening which is an opening with a reduced diameter; said inner rod has a first flange in rear of said position limiting area and with a diameter larger than that of said opening with said reduced diameter.

3. The retractable contact-control pen for an electric device as in claim 2, wherein: said inner rod is provided with a second flange on said front end thereof, and of which said positioning hole, said compression spring and said two protrusions are allocated between said first and said second flanges.

4. The retractable contact-control pen for an electric device as in claim 2, wherein: said inner rod is hollow, said first flange is provided on a cylindrical collar which fixedly wraps a front end of said hollow inner rod, said cylindrical collar is provided thereon with through holes for extending therethrough of said two protrusions.

5. The retractable contact-control pen for an electric device as in claim 1, wherein: said inner rod is solid, said position limiting area is extended out of a tailing end of said inner rod.

6. The retractable contact-control pen for an electric device as in claim 1, wherein: said contact-control pen has more than one positioning hole, said positioning holes are provided to have therein each a compression spring and two protrusions.

7. The retractable contact-control pen for an electric device as in claim 6, wherein: said positioning holes are neighbored with each other and are arranged to be perpendicular one to the other.

8. The retractable contact-control pen for an electric device as in claim 1, wherein: cross-sections of said outer rod and said inner rod are circular, elliptical or polygonal able to fit with each other.

9. The retractable contact-control pen for an electric device as in claim 1, wherein: an inner surface of each of said protrusions is provided with a recess for embedding therein of said compression spring, outer surfaces of said two protrusions are each an arci form protruding surface in coincidence with said inner wall of said outer rod.

10. The retractable contact-control pen for an electric device as in claim 1, wherein: said retractable contact-control pen has a pen cap on a tailing end of said inner rod, and a nib on a front end of said outer rod.

11. The retractable contact-control pen for an electric device as in claim 1, wherein: a nib is provided on a tailing end of the inner rod, and a pen cap is provided on a front end of said outer rod.
